(19) United States
(12) Patent Application Publication
(10) Pub. No.: US 2010/0236694 A1
(43) Pub. Date: Sep. 23, 2010

(54) Method and Tape for Adhesive Locking of a Threaded Fastener

(75) Inventor: Michael A. Kardasz, Troy, MI (US)

Correspondence Address: Charles E. Leahy, 226 Moran Road, Grosse Pointe Farms, MI, 48236, US

(73) Assignee: GM GLOBAL TECHNOLOGY OPERATIONS, INC., Detroit, MI (US)

(21) Appl. No.: 12/407,180

(22) Filed: Mar. 19, 2009

(51) Int. Cl. F16B 39/00; B32B 7/12

(52) U.S. Cl. 156/91; 428/321.5

(57) ABSTRACT

A thread-locking method and tape includes providing a sheet of flexible backing material having disposed thereon a filler material containing adhesive microcapsules. The thread-locking tape is wrapped around a male threaded fastener with the filler material pressed into the threads, and then the male threaded fastener into a female threaded fastener so that the adhesive bursts from the microcapsules and is distributed into contact with the threads on both the male and female fasteners. The backing material is either removable by peeling from the filler material before threading of the male threaded fastener into the female threaded fastener, or the backing material remains in place and is shredded by the threads of the threaded female fastener so that the adhesive is released into contact with the threads of both the male threaded fastener and the female threaded fastener.

### FIELD OF THE INVENTION

The present invention relates to a method for adhesive locking of a threaded fastener and more particularly provides a thread-locking tape containing micro-encapsulated adhesive which is wrapped around a male threaded fastener prior to its installation into a female threaded fastener.

### BACKGROUND OF THE INVENTION

It is known in the automotive and other industries that a male threaded fastener may be installed into a female threaded fastener for attaching together various components, such as vehicle bodies, vehicle engines, and vehicle transmissions. Because the fasteners and the various components are subjected to vibration during their normal usage, it has been recognized that an adhesive can be employed on the fastener threads in order to lock the fasteners against loosening.

It has been known in the prior art to apply an anaerobic adhesive onto the threads just prior to installation. The anaerobic adhesives will cure over time when deprived of contact with the air.

It has also been known to dip or paint a liquid adhesive onto one of the threaded fasteners. The liquid dries sufficiently to form a skin which retains the adhesive on the fastener threads and permits handling of the fasteners without activating the adhesive. These adhesives typically employ an adhesive that is micro-encapsulated. During assembly of the fasteners, the microcapsules are broken to release the adhesive. It would be desirable to provide a new and improved method for delivering an adhesive to the mating interface between a male threaded fastener and a female threaded fastener.

### SUMMARY OF THE INVENTION

A thread-locking method and tape includes providing a sheet of flexible backing material having disposed thereon a filler material containing adhesive microcapsules to form tape. The thread-locking tape is wrapped around a male threaded fastener with the filler material pressed into the threads. Then, the male threaded fastener is installed into a female threaded fastener, and the pressure applied causes the adhesive to burst from the microcapsules and the adhesive is distributed into contact with the threads on both the male and female fasteners. The backing material is either removable by peeling from the filler material before threading of the male threaded fastener into the female threaded fastener, or the backing material remains in place and is shredded by the threads of the threaded female fastener so that the adhesive can contact with the threads of both the male threaded fastener and the female threaded fastener.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a first thread-locking tape according to the invention.

FIG. 2 is a side elevation of a male threaded fastener having the thread-locking tape wrapped thereon and poised for installation into a female threaded fastener.

FIG. 3 is a side elevation of a male threaded fastener having the thread-locking tape and the backing material being removed from the thread-locking tape prior to the installation of the male threaded fastener into a female threaded fastener.

FIG. 4 shows another embodiment of the thread-locking tape.

### DETAILED DESCRIPTION OF THE EXEMPLARY EMBODIMENTS

The following description of certain embodiments is exemplary in nature and is not intended to limit the invention, its application, or uses.

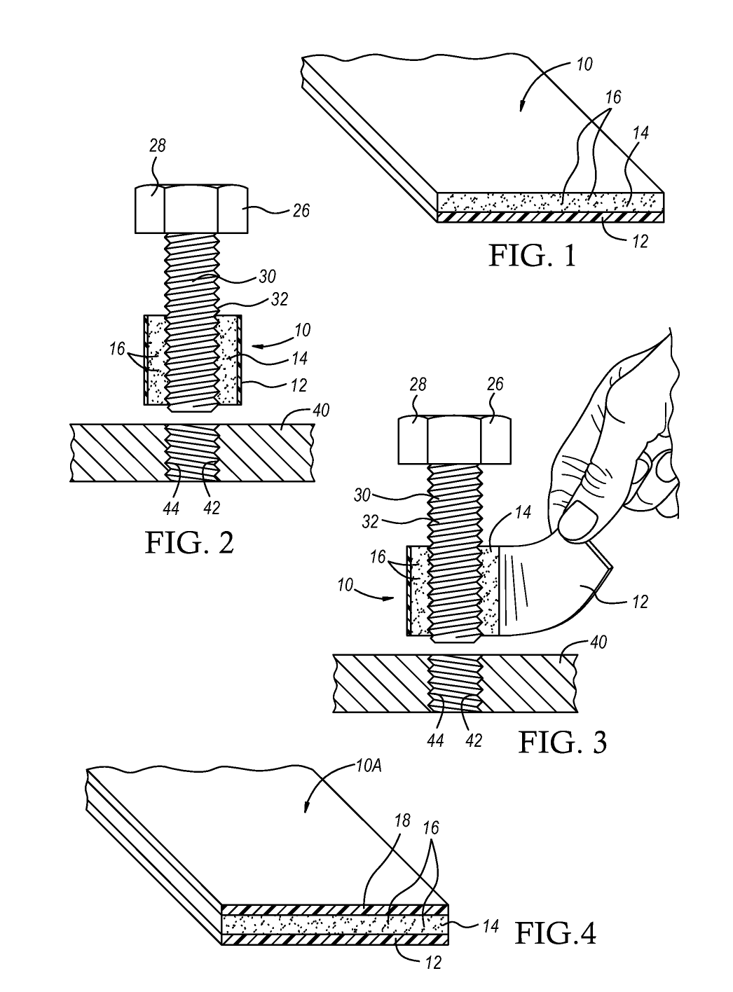

Referring to FIG. 1, it is seen that a piece of thread-locking tape 10 is comprised of a backing material 12 having a layer of filler material 14 disposed thereon. Microcapsules 16 of adhesive are carried within the filler material 14. The backing material 12 may be paper or a Teflon tape material similar to that used in the plumbing industry, or other flexible sheet material such as a plastic or cellulose material. The filler material 14 is compounded of constituent ingredients such as a solvent, binder, hardener, and a pigment. In addition, the filler material 14 may include a friction modifying material, such as wax or Teflon, which will modify the frictional characteristics of the filler material 14. The adhesive contained within the microcapsules 16 may be a one-part adhesive or a two-part adhesive such as a two-part epoxy. Thus, the microcapsules 16 may be identical in their formulation, or the microcapsules 16 may have different materials therein, including a first part in some of the microcapsules 16 and a second part in other of the microcapsules 16, which parts, when mixed together, will form the constituents of the two-part adhesive.

Referring to FIG. 2, it is seen that a male threaded fastener 26 has a hex head 28, a shank 30, and male threads 32. The male threaded fastener 26 will be installed into a female threaded fastener 40 having a bore 42 with female threads 44. It will be appreciated that the female fastener 40 can be a nut or can be integral with a casting or a stamping or other structural component. As seen in FIG. 2, a piece of the thread-locking tape 10 of FIG. 1 has been wrapped around the male threads 32 of the male threaded fastener 26. For clarity in the drawings, the thickness of the thread-locking tape is exaggerated so as to better show that the filler material 14 of the thread-locking tape 10 has been wrapped around the shank 30 and pressed against and into the male threads 32 so that the thread-locking tape 10 has become effectively self-adhered to the male threads 32. Thus, it will be understood that the filler material 14 is pliable and soft enough to be molded into the shape of the male threads 32.

This application of the thread-locking tape 10 onto the male threads 32 of the male threaded fastener 26 can be performed anywhere in the supply chain from the male threaded fastener manufacturer to the assembly plant where the male threaded fastener 26 will be installed into the female threaded fastener 40. During shipping and handling, the backing material 10 will serve to protect the filler material 14 and its microcapsules 16 from excessive physical contact with other objects which might prematurely rupture the microcapsules 16. The thread-locking tape 10 can be made in strips that are scored along the length thereof to permit tearing in pieces of proper size. Or the thread-locking tape 10 can be made in large sheets that are pre-cut to size. Or the thread-locking tape 10 can be made in individual small pieces of the proper size.

Referring again to FIG. 2, it will be appreciated that the male threaded fastener 26 can be threadedly installed into the female threaded fastener 40 with the backing material 12 remaining in place on the male threaded fastener 26. In particular, it will be appreciated that as the installation progresses the backing material 12 will be severed and shredded by its being compressed between the male threads 32 and the female threads 44. Simultaneously, the compression of the microcapsules 16 will cause a bursting of the microcapsules 16 to release the adhesive and mix the adhesive. The adhesive will thus become exposed to both the male threads 32 and the female threads 44. Hence, upon curing of the adhesive, the male threaded fastener 26 will be adhesively secured within the female threaded fastener 40.

Referring now to FIG. 3, another embodiment of the method of this invention is shown. FIG. 3 shows that an assembly operator is unpeeling the backing material 12 from the filler material 14. Thus, upon removal of the backing material 12, the filler material 14 is fully exposed. Then, upon the installation of the male threaded fastener 26 into the female threaded fastener 40, the filler material 14, with its microcapsules 16, is directly exposed for contact with both the male threads 32 of the male threaded fastener 26 and the threads 42 of the female threaded fastener 40. Accordingly, in the embodiment of FIG. 3, the removal of the backing tape 12 enables the full exposure of the adhesive to the threads without the interposition or shredding of any backing material 12.

Referring to FIG. 4, another embodiment of the thread-locking tape is shown and is designated 10A. The thread-locking tape 10A is similar to FIG. 1 in that it includes a layer of backing material 12, a filler material 14 disposed on the backing material 12, and a multitude of microcapsules 16 within the filler material 14. In addition, however, as shown in FIG. 4, a second layer of backing material 18 is applied over top of the filler material 14 so that the filler material 14 has become fully sandwiched between the backing material layers 12 and 18. Thus, the thread-locking tape 10A of FIG. 4 is more completely armored and protected against any premature application of pressure that might burst the microcapsules 16. Accordingly, when it is desired to apply the thread-locking tape 10A of FIG. 4 to a male threaded fastener 26, the thread-locking tape 10A can be applied to the male threaded fastener 26 by removing either one of the backing materials 12 or 18 in order to press the filler material 14 into the male threads 30 of the male threaded fastener 26. Then, after filler material 14 has been pressed onto the male threaded fastener 32, the other backing material can be removed, or in the alternative the male threaded fastener 26 can be installed with the other backing material remaining in place and being severed and shredded, as was the case in the example of FIG. 2.

Yet another possibility is that the thread-locking tape 10A of FIG. 4 can be used with neither of the backing materials removed prior to installation of the thread-locking tape 10A onto the male threaded fastener 26. In this case, the backing material, 12 or 18, that will be pressed into the male threaded fastener 26 must be sufficiently pliant in order to fit significantly within the depth of the male threads 32 sufficient to retain the thread-locking tape 10A on the male threaded fastener 26 prior to and during its installation.

Thus, it is seen that the invention provides a new and improved method for locking a threaded fastener via the use of a thread-locking tape comprised of an adhesive microcapsule containing filler material that is disposed upon a flexible backing material or between two layers of backing material.

The description of the invention is merely exemplary in nature and, thus, variations thereof are intended to be within the scope of the invention.

What is claimed is:

1. A method for locking a male threaded fastener to a female threaded fastener comprising:
providing a sheet of flexible backing material having disposed thereon a filler material containing adhesive microcapsules to form a thread-locking tape;
wrapping the thread-locking tape around a male threaded fastener; and
installing the male threaded fastener into a female threaded fastener so that the adhesive bursts from the microcapsules and is distributed into contact with the threads on both the first and second fasteners.

2. The method of claim 1 further comprising the backing material being paper.

3. The method of claim 1 further comprising the backing material being Teflon tape so that the Teflon tape reduces the friction encountered during the installation of the male threaded fastener.

4. The method of claim 1 further comprising the tape being wrapped on the male threaded fastener with the filler material facing the threads and the filler material being pressed into the threads and being sufficiently pliable to be retained upon the male threads.

5. The method of claim 4 further comprising the additional step of peeling the backing material off of the filler material prior to installing the male threaded fastener into the female threaded fastener.

6. The method of claim 4 further comprising said backing material being shredded by its engagement with the threads of the female threaded fastener during the installation of the male threaded fastener into the female threaded fastener so that the backing material does not prevent the adhesive from contacting the threads of the female threaded fastener.

7. The method of claim 1 further comprising after disposing the filler material on the backing material, then applying another layer of the backing material so the filler material is sandwiched between two backing materials.

8. The method of claim 7 comprising removing one of the layers of backing material from the filler material prior to wrapping the tape around the male threaded fastener so that filler material is exposed to the threads and formed into the threads sufficiently to retain the tape on the male threaded fastener without bursting the microcapsules.

9. The method of claim 8 further comprising after wrapping the tape around the male threaded fastener then removing the other of the layers of the backing material so that upon the installation of the male threaded fastener into the female threaded fastener and the consequent bursting of the microcapsules the adhesive will be exposed directly to the threads of the female threaded fastener.

10. The method of claim 8 further comprising after wrapping the tape around the male threaded fastener then installing the male threaded fastener into the female threaded fastener and the threads of the female threaded fastener shredding the other layer of backing material so that the adhesive bursting from the microcapsules the adhesive will be exposed directly to the threads of the female threaded fastener.

11. The method of claim 1 further comprising the adhesive microcapsules all containing the same one part adhesive.

12. The method of claim 1 further comprising the adhesive microcapsules including first microcapsules containing one part of a two part adhesive and second microcapsules containing the other part of a two part adhesive, and the threading of the male fastener into the female threaded fastener bursting the first and second microcapsules and mixing the one part and the other part.

13. A method for locking a male threaded fastener to a female threaded fastener comprising:
providing at least one sheet of flexible backing material;
disposing a pliant filler material containing adhesive microcapsules onto the backing material to form a thread-locking tape;
wrapping the thread-locking tape around a male threaded fastener and pressing the pliant filler material into the threads so that the thread-locking tape becomes embedded upon the male threaded fastener; and
installing the male threaded fastener into a female threaded fastener so that pressure is applied and to burst the microcapsules thereby distribute the adhesive into contact with the threads on both the first and second fasteners.

14. The method of claim 13 further comprising the additional step of peeling the backing material off of the filler material prior to installing the male threaded fastener into the female threaded fastener.

15. The method of claim 13 further comprising said backing material remaining in place during the threading of the male threaded fastener into the female threaded fastener and being shredded by its engagement with the threads of the female threaded fastener during the installation of the male threaded fastener into the female threaded fastener so that the backing material does not prevent the adhesive from contacting the threads of the female threaded fastener.

16. A thread-locking tape for adhesively locking a male threaded fastener to a female threaded fastener comprising:
a sheet of flexible backing material;
a filler material disposed on the sheet of flexible backing material;
a micro-encapsulated adhesive disposed within the filler material;
said filler material being sufficiently pliable to enable pressing of the filler material into the threads of male threaded fastener when the thread-locking tape is wrapped around the male threaded fastener so that the filler material is retained upon the threads; and
said micro-encapsulated adhesive being released upon the threading of the male threaded fastener into the female threaded fastener.

17. The thread-locking tape of claim 16 further comprising said backing material being of a material that is either removable by peeling from the filler material before threading of the male threaded fastener into the female threaded fastener or a material that is shredable by the threads of the threaded female fastener so that the adhesive is released into contact with the threads of both the male threaded fastener and the female threaded fastener.

18. The thread-locking tape of claim 17 further comprising a second layer of backing material disposed over the layer of filler material so that the filler material is sandwiched between two layers of backing material.
wrapping the tape around a male threaded fastener; and
installing the male threaded fastener into a female threaded fastener so that the adhesive bursts from the microcapsules and is distributed into contact with the threads on both the male threaded fastener and the female threaded fastener.

19. The method of claim 17 further comprising the backing material being paper.

20. The method of claim 17 further comprising the backing material being Teflon tape so that the Teflon tape reduces the friction encountered during the installation of the male threaded fastener.
